(19) United States
(12) Patent Application Publication
(10) Pub. No.: US 2016/0100373 A1
(43) Pub. Date: Apr. 7, 2016

(54) Signal Format for Cell Search and Synchronization in Wireless Networks

(71) Applicant: Mediatek Inc., Hsinchu (TW)

(72) Inventor: Ju-Ya Chen, Kaohsiung City (TW)

(21) Appl. No.: 14/868,665

(22) Filed: Sep. 29, 2015

Related U.S. Application Data
(60) Provisional application No. 62/060,781, filed on Oct. 7, 2014.

(51) Int. Cl. H04W 56/00; H04L 27/26; H04L 12/807

(52) U.S. Cl. CPC H04W 56/001; H04L 47/27; H04L 27/2601; H04W 88/02

(57) ABSTRACT

A synchronization signal format for a cell search method is proposed to reduce cell search complexity and cell search time. A synchronization signal is embedded with a unique sequence that is consecutively repeated multiple times in time domain. Different unique sequences represent different control information to be broadcasted from a base station to user equipments via synchronization signal transmissions. A two-stage cell search method is then applied in accordance with the synchronization signal format. In a first acquisition stage, a coarse location of the synchronization signal is acquired. In a second fine searching stage, the unique sequence is detected within a searching range of the coarse location.

### CROSS REFERENCE TO RELATED APPLICATIONS

This application claims priority under 35 U.S.C. §119 from U.S. Provisional Application No. 62/060,781, entitled “Signal format for cell search/synchronization,” filed on Oct. 7, 2014, the subject matter of which is incorporated herein by reference.

### TECHNICAL FIELD

The disclosed embodiments relate generally to wireless communication, and, more particularly, to signal format for cell search and synchronization in wireless networks.

### BACKGROUND

Long Term Evolution (LTE) is an improved universal mobile telecommunication system (UMTS) that provides higher data rate, lower latency and improved system capacity. To provide high data rate in a frequency selective fading environment, the downlink transmission utilizes Orthogonal Frequency Division Multiple Access (OFDMA) at the physical layer. In an LTE system, an evolved universal terrestrial radio access network (E-UTRAN) includes a plurality of base stations, referred as evolved Node-Bs (eNBs), communicating with a plurality of mobile stations, referred as user equipment (UE). A UE may communication with a base station or an eNB via downlink and uplink.

Cell search as well as synchronization in the LTE system is performed in each UE by using both the Primary Synchronization Signal (PSS) and Secondary Synchronization Signal (SSS). The LTE wireless cellular system is designed with orthogonal frequency domain multiple access (OFDMA) in the physical layer. The incoming user data bits are multiplexed onto the assigned sub-carriers in frequency domain and transmitted as a single time-domain signal in downlink. This is accomplished by an inverse fast Fourier transform (IFFT) on the user data bits. For facilitating cell search procedures, known bit patterns are transmitted in specific time and frequency slots for the mobile devices to be able to identify the cell's timing and its associated identifier (cell ID). A mobile device after being powered on, attempts to measure the received wideband power and attempts to perform cell search using the downlink synchronization channels.

Cell search is important in cellular or wireless networks. A UE uses cell search procedure to obtain the cell identity, time/frequency/spatial synchronization, or other system/network information. The cell search procedure in LTE system can be performed in three steps. The first step is carried out by correlating the received Primary Synchronization Signal (PSS) samples to determine the cell's group identity out of three possible values and its timing information by determining the 5 ms boundary of cell's signal transmission. The latter is because PSS signal is transmitted as the last OFDM symbol in 0th and 5th subframe of a 10 ms radio frame. The second step is correlating the received samples of the Secondary Synchronization Signal (SSS) to determine the cell identifier and frame timing. The third step is to verify the cell identification. The cell searching time usually depends on the number of cell identities or the amount of carried system information.

The bandwidth shortage increasingly experienced by mobile carriers has motivated the exploration of the underutilized Millimeter Wave (mmWave) frequency spectrum between 3 G and 300 G Hz for the next generation broadband cellular communication networks. The available spectrum of mmWave band is two hundred times greater than the conventional cellular system. The mmWave wireless network uses directional communications with narrow beams and can support multi-gigabit data rate. For control purpose, a set of coarse TX/RX control beams are provisioned by a base station in the mmWave cellular system. The base station broadcasts synchronization signals in control channels with spatial-domain control beam patterns for cell search and handover applications. The synchronization signal is periodically transmitted with a small duty cycle instead of a constantly broadcasting signal.

In addition to cell identities, control beam identity information also needs to be decoded by each UE in cell search procedure for directional cellular or wireless networks. As a result, cell search time increases. A solution is sought to design a synchronization signal to reduce the cell search time in directional cellular or wireless systems.

### SUMMARY

A synchronization signal format for a cell search method is proposed to reduce cell search complexity and cell search time. A synchronization signal is embedded with a unique sequence that is consecutively repeated multiple times in time domain. Different unique sequences represent different control information to be broadcasted from a base station to user equipments via synchronization signal transmissions. A two-stage cell search method is then applied in accordance with the synchronization signal format. In a first acquisition stage, a coarse location of the synchronization signal is acquired. In a second fine searching stage, the unique sequence is detected within a searching range of the coarse location.

In one embodiment, a user equipment (UE) receives a time-domain synchronization signal transmitted from a base station in a mobile communication network. The synchronization signal carries a unique sequence with consecutive time-domain repetition. The UE performs a stage-1 signal detection by self-correlating the synchronization signal and deriving a coarse location of the synchronization signal. The UE performs a stage-2 signal detection by cross correlating the synchronization signal with a candidate sequence based on the coarse location and thereby detecting a fine location of the synchronization signal and the unique sequence. In one example, a plurality of control beams is configured to cover an entire service area of a cell for transmitting the synchronization signal. The unique sequence identifies control information comprising at least one of a cell ID and a beam ID of the base station.

In another embodiment, a base station allocates radio resources in a mobile communication network. The radio resources are periodically allocated for synchronization signal transmission. The base station transmits a synchronization signal to a plurality of UEs over the allocated radio resources. The synchronization signal is embedded with a unique sequence. The unique sequence is repeated for n times and inserted in one or more OFDM symbols in time domain. In one example, a plurality of control beams is configured to cover an entire service area of a cell for transmitting the synchronization signal. The unique sequence identifies control information comprising at least one of a cell ID and a beam ID of the base station.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a beamforming mmWave mobile communication network with a novel synchronization signal format in accordance with one novel aspect.

FIG. 2 is a simplified block diagram of a user equipment (UE) that carry certain embodiments of the present invention.

FIG. 3 illustrates one embodiment of a two-stage cell search and synchronization in a beamforming mmWave mobile communication network.

FIG. 4 illustrates a novel signal format of a synchronization signal for cell search and synchronization in a beamforming mmWave system.

FIG. 5 illustrates a first stage of the cell search method based on the novel signal format.

FIG. 6 illustrates a second stage of the cell search method based on the novel signal format.

FIG. 7 is a flow chart of a method of a two-stage cell search based on a novel synchronization signal format in accordance with one novel aspect.

FIG. 8 is a flow chart of a method of transmitting synchronization signals with a novel signal format for reduced cell search time.

### DETAILED DESCRIPTION

Reference will now be made in detail to some embodiments of the invention, examples of which are illustrated in the accompanying drawings.

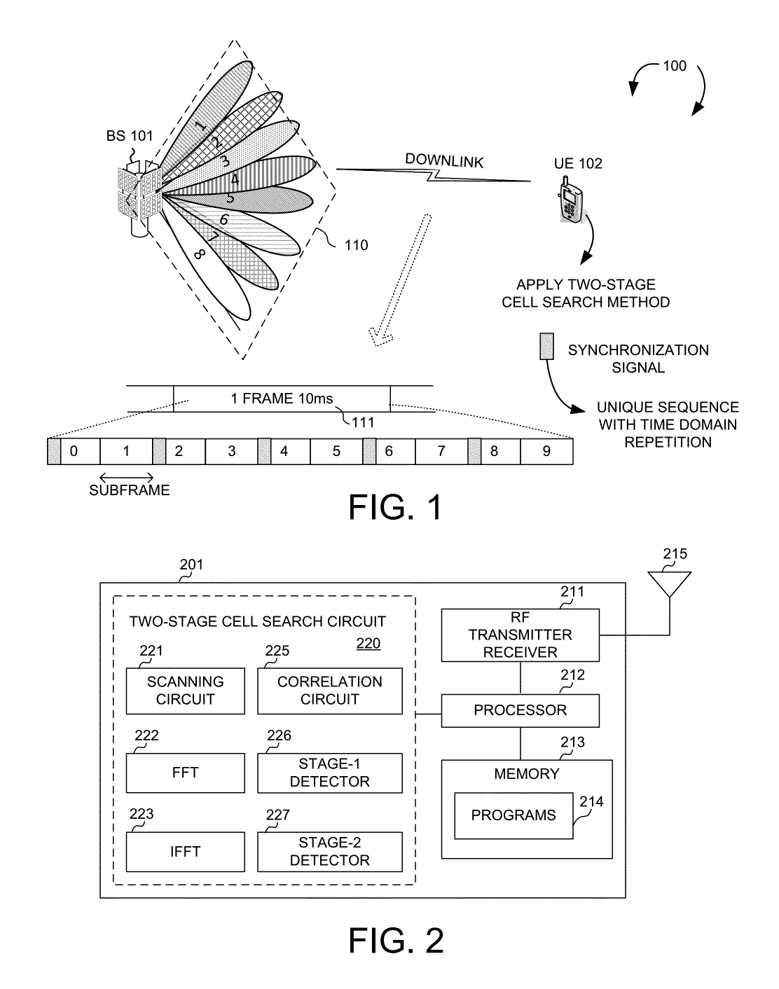

FIG. 1 illustrates a beamforming mmWave mobile communication network 100 with a novel synchronization signal format in accordance with one novel aspect. Beamforming mmWave mobile communication network 100 comprises a base station BS 101 and a user equipment UE 102. The mmWave cellular network uses directional communications with narrow beams and can support multi-gigabit data rate. Directional communications are achieved via digital and/or analog beamforming, wherein multiple antenna elements are applied with multiple sets of beamforming weights to form multiple beams. For example, BS 101 is directionally configured with multiple cells, and each cell (e.g., cell 110) is covered by a set of coarse resolution control beams CB1 to CB8.

A base station (BS) broadcasts synchronization signals in control channels with spatial-domain control beam patterns for cell search and handover applications. Each control beam broadcasts minimum amount of cell-specific and beam-specific information similar to System Information Block (SIB) or Master Information Block (MIB) in LTE systems. Each control beam may also carry UE-specific control or data traffic. Each control beam transmits a set of known synchronization signals for the purpose of cell search, initial time-frequency synchronization, identification of the control beam that transmits the synchronization signals, and measurement of radio channel quality for the control beam that transmits the synchronization signals.

The cell searching time usually depends on the number of cell identities or the amount of carried system information. In LTE systems, there are 504 cell identities, which are divided into 3*168 cell groups. Cell search is performed by using both the Primary Synchronization Signal (PSS) and Secondary Synchronization Signal (SSS). The PSS gives UE information about to which of the three groups of physical layers the cell belongs. The SSS is decoded right after PSS, which defines the cell group identity directly. The hierarchical PSS/SSS structure is designed to reduce the cell search time. However, in directional mmWave networks, control beam identity information also needs to be decoded by each UE in the cell search procedure. For example, cell 110 is configured with eight control beams CB1 to CB8, and both control beam ID and cell ID need to be sent to the UE via the synchronization signal. If each cell is configured with eight control beams, then the total number of cell ID/beam ID can reach 504*8. As a result, cell search time increases.

In accordance with one novel aspect, to reduce cell search complexity and cell search time, a synchronization signal format for cell search is proposed. In the example of FIG. 1, the downlink channels use Orthogonal Frequency Division Multiple Access (OFDMA). Each OFDM radio frame (e.g., frame 111) is 10 ms long. Each frame is divided into ten subframes of 1 ms. Subframes are also split into 0.5 ms slots. Such slot can contain seven OFDM symbols with normal Cyclic Prefix (CP) length and six with extended CP (not shown). A synchronization channel is allocated periodically, for example, during the first OFDM symbol of every other subframe. The periodicity of the synchronization channel is configurable. As illustrated in FIG. 1, each synchronization signal is embedded with a unique sequence that is repeated n times in time domain and then inserted in the OFDM symbol. Different unique sequence represents different control information. A two-stage cell search method is proposed in accordance with the synchronization signal format to reduce cell search time. In a first acquisition stage, a coarse location of the synchronization signal is acquired. In a second fine searching stage, the unique sequence is detected within the searching range of the coarse location.

FIG. 2 is a simplified block diagram of user equipment UE 201 that carry certain embodiments of the present invention. UE 201 has an antenna array 215 with multiple antenna elements, which transmits and receives radio signals. A radio frequency (RF) transceiver module 211, coupled with the antenna, receives RF signals from antenna 214, converts them to baseband signals and sends them to processor 212. RF transceiver 211 also converts received baseband signals from processor 212, converts them to RF signals, and sends out to antenna 215. Processor 212 processes the received baseband signals and invokes different functional modules to perform features in UE 201. Memory 213 stores program instructions and data 214 to control the operations of UE 201.

UE 201 also includes function modules that carry out different tasks in accordance with embodiments of the current invention. The functional modules are circuits that can be implemented and configured by hardware, firmware, software, and any combination thereof. For example, UE 201 comprises a two-stage cell search circuit 220 that performs cell search and synchronization with a serving base station. Two-stage cell search circuit 220 further comprises a scanning circuit 221 that listens to synchronization signals during scanning intervals, a FFT circuit performs FFT on a received signal from time domain to frequency domain, an IFFT circuit performs IFFT on a received signal from frequency domain to time domain, a correlation circuit that correlates two signals (which includes both self-correlation and cross-correlation), a stage-1 detector that performs stage-1 detection of a coarse location of the synchronization signal, and a stage-2 detector that performs stage-2 detection of a fine location of the synchronization signal and detects the unique sequence embedded in the synchronization signal. Based on the fine location, UE 201 is able to synchronize to its serving base station. Furthermore, based on the unique sequence, UE 201 is able to decode the cell ID, beam ID, and other control information broadcasted by its serving base station.

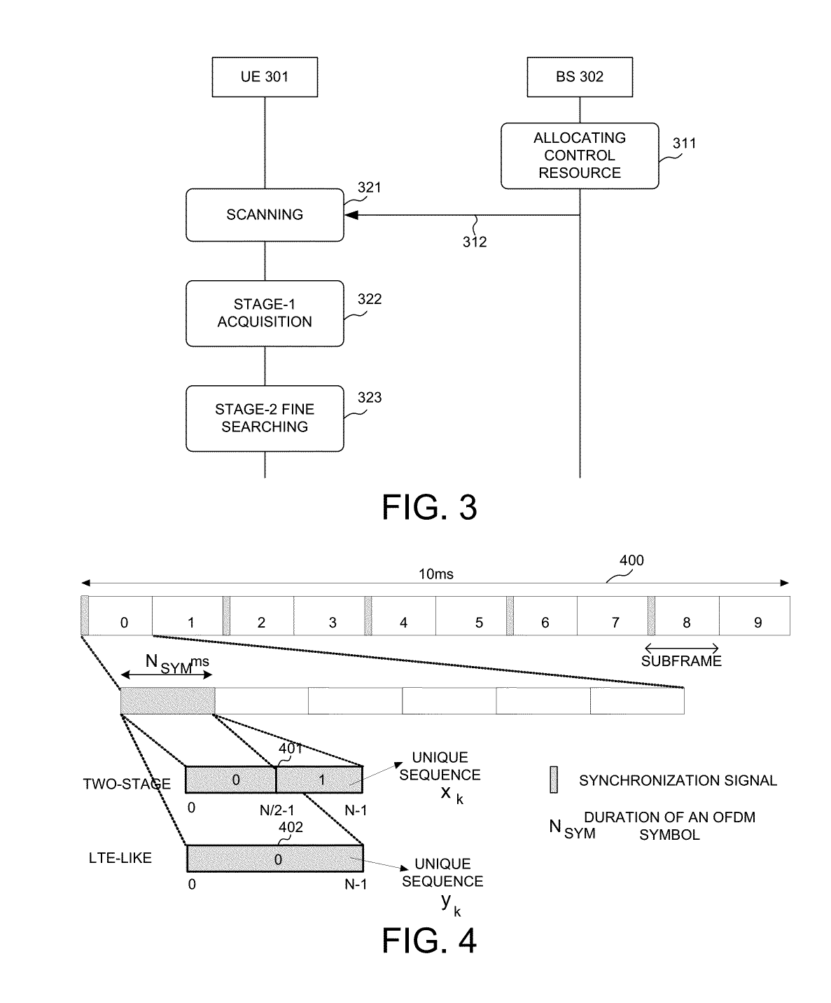

FIG. 3 illustrates one embodiment of a two-stage cell search and synchronization method in a beamforming mobile communication network. The mobile communication network comprises a UE 301 and a base station BS 302. In step 311, BS 302 allocates control resources for periodically broadcasting synchronization signals to its serving UEs. In step 312, BS 302 periodically broadcasts synchronization signals over the allocated radio resources via directionally configured control beams. Control information is embedded within the synchronization signals. In step 321, UE 301 performs scanning and receives the synchronization signals during scanning intervals. In step 322, UE 301 performs a stage-1 signal detection, which is an acquisition stage. The purpose of this stage is to reduce the search time and find out the possible searching range for stage-2. In step 323, UE 301 performs stage-2 signal detection, which is a fine searching stage. During the stage-2 signal detection, the UE matches the synchronization signal to identify the embedded control information.

FIG. 4 illustrates a novel signal format of a synchronization signal for cell search and synchronization in a beamforming system. As illustrated in FIG. 4, each OFDM radio frame (e.g., radio frame 400) is 10 ms long. Each radio frame is divided into ten subframes of 1 ms. A synchronization channel is allocated periodically, for example, during the first OFDM symbol of every other subframes. The periodicity of the synchronization channel is configurable. Furthermore, the synchronization signal is embedded with a unique sequence xₖ that is repeated n times in time domain (e.g., n=2, repeated twice as depicted in FIG. 4). Different unique sequences represent different control information.

In one example of two-stage cell search method, the synchronization signal occupies one OFDM symbol length (Ns_{ym}ms), which contains N time-domain samples. The unique sequence xₖ has a length of N/2 time-domain values. The first copy of xₖ is inserted in the first N/2 time-domain samples of the OFDM symbol 401, and the second copy of xₖ is inserted in the second N/2 time-domain samples of the OFDM symbol 401. On the other hand, for LTE-like cell search method, the synchronization signal also occupies one OFDM symbol 402, which contains N time-domain samples. OFDM symbol 402 carries a unique sequence yₖ having a length of N, and there is no time-domain repletion for the unique sequence yₖ. Because of the time-domain repetition of the synchronization signal in OFDM symbol 401, the proposed two-stage cell search method can be achieved as follows. In a first stage, self-correlation is applied by the receiver to find out the coarse location of synchronization signal. In a second stage, the receiver matches the unique sequence within the searching range of the coarse location to find out the control information. The complexity of the two-stage cell search method is lower than that of LTE-like cell search method.

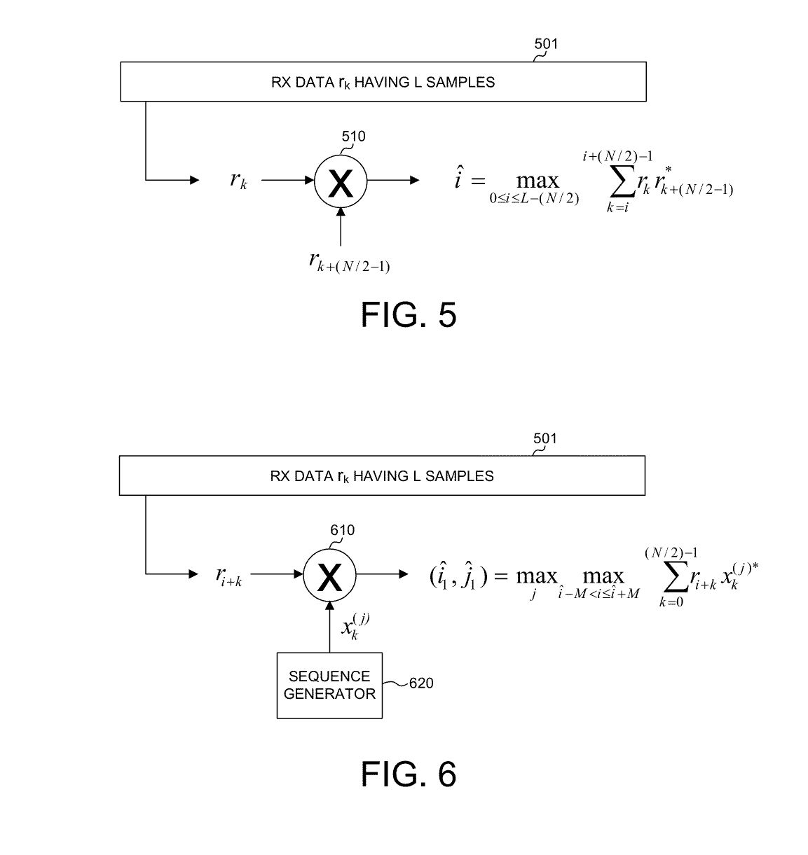

FIG. 5 illustrates a first stage of the cell search method based on the novel synchronization signal format. During the first stage, a UE receives a time-domain signal 501 denoted as rₖ for a total of L samples during an observation window, where k indicates the sampling instance. The UE then uses a correlator 510 to perform self-correlation for the received time-domain signal rₖ as follows:

$$\hat{i} = {max}_{0 \leq i \leq L - ( N / 2 )} {\sum }_{k = i}^{i + ( N / 2 ) - 1} {r}_{k} {r}_{k + ( N / 2 - 1 )}^{*}$$

### Where

Received time-domain signal is denoted as rₖ

Length of unique sequence xₖ is N/2

Length of the observation of received signal is L

Number of multipliers is L−(N/2)+1

Number of adders is 2L−(N/2)+2

Based on the self-correlation result, a coarse location î can be found if a maximum correlation is reached. Note that power normalization is not shown here for simplicity. Further, maximization is not the only one approach. The coarse location can also be found if the correlation result reaches a threshold value. It can be seen that the number of computation required in such self-correlation is relatively small because the same sequence is simply shifted in time domain during the correlation. Based on the novel signal format of time-domain repetition, rₖ and r_{k+(N/2-1)} (e.g., two sequences having a time distance of N/2) are exactly the same if rₖ is captured at the correct time instance î during the observation window. As a result, the self-correlation between rₖ and r_{k+(N/2-1)} will produce a maximum result.

FIG. 6 illustrates a second stage of the cell search method based on the novel synchronization signal format. During the second stage, the UE receives the same time-domain signal 501 denoted as rₖ for a total of L samples during an observation window, where k indicates the sampling instance. The UE then uses a correlator 610 to perform cross-correlation between the received time-domain signal rₖ and each of the possible unique sequences xₖ, and then find unique sequence number (j1) and fine symbol timing (i1) by cross-correlation as follows:

$$( {\hat{i}}_{1} , {\hat{j}}_{1} ) = {max}_{j} {max}_{\hat{i} - M < i \leq \hat{i} + M} {\sum }_{k = 0}^{( N / 2 ) - 1} {r}_{i + k} {x}_{k}^{{( j )}^{*}}$$

### Where

xₖ^{(j)} is jth unique sequence

Number of unique sequence is J, which depends on number of control beam and cell ID

Length of certain fine searching range is 2M+1

Number of multipliers is J(2M+1)(N/2)

Number of adders is J(2M+1)((N/2)−1)

The unique sequence number (j₁) is determined when a maximum cross correlation result is achieved among all candidate sequences. The searching range for the cross-correlation in stage-2 is plus or minus M sampling instances of the coarse location î determined from stage-1. As a result, the number of computation required in such cross-correlation is relatively small because of the restricted searching range of (2M+1). The number of total multipliers is L−(N/2)+1+J(2M+1)(N/2), and the number of total adders is 2L−(N/2)+2+J(2M+1)((N/2)−1). Overall, the complexity of the two-stage cell search method is much lower than the LTE-like cell search.

For LTE-like cell search, the synchronization signal contains a unique sequence yₖ having a length N. The unique sequence occupies an entire OFDM symbol and has no time-domain repetition. The corresponding cell-search method is to find unique sequence number (j₂) and fine symbol timing (i₂) by cross-correlation in full range as follows:

$$( {\hat{i}}_{2} , {\hat{j}}_{2} ) = {max}_{j} {max}_{0 \leq i \leq L - N} {\sum }_{k = 0}^{N - 1} {r}_{i + k} {y}_{k}^{{( j )}^{*}}$$

### Where

Received time-domain signal is denoted as rₖ

Length of unique sequence yₖ is N

Length of the observation of received signal is L

yₖ^{(j)} is jth unique sequence

Number of unique sequence is J, which depends on number of control beam and cell ID

Number of multipliers is J(L−N+1)N

Number of adders is J(L−N+1)(N−1)

In one specific example, assume N=2048, L=286720, J=4032, and M=128. The total number of multipliers/adders in the two-stage method is 1.1*10⁹, and the total number of multipliers/adders in the LTE-like method is 2.4*10¹². It can be seen that the complexity of LTE-like cell search method is 2000 times of that of the two-stage cell search method in this example.

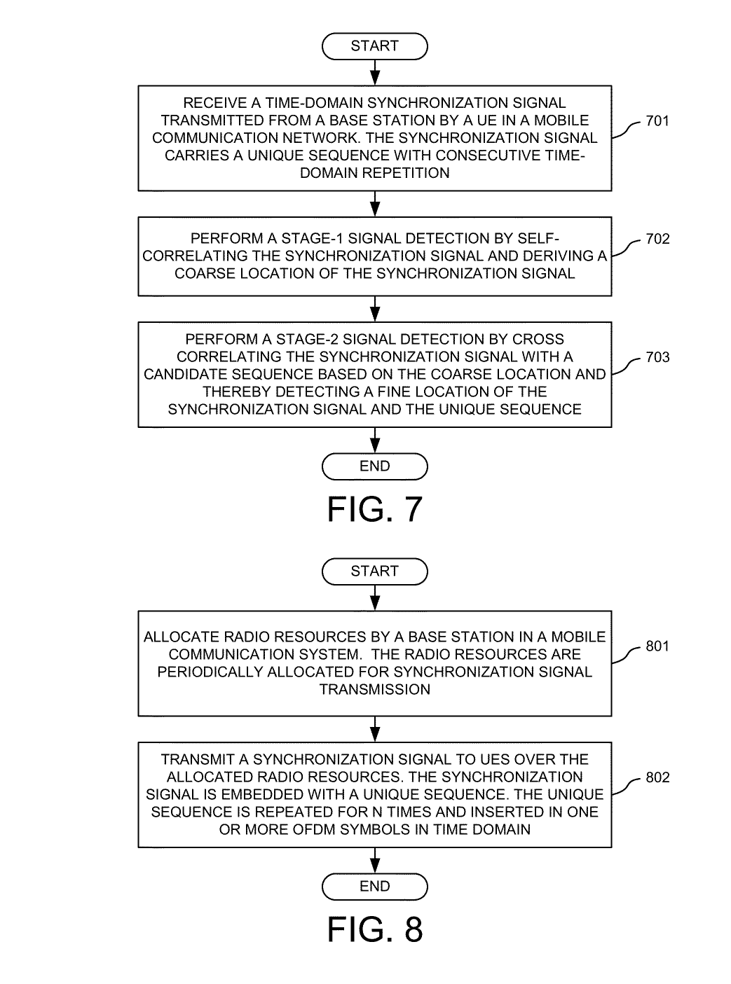

FIG. 7 is a flow chart of a method of a two-stage cell search based on a novel synchronization signal format in accordance with one novel aspect. In step 701, a user equipment (UE) receives a time-domain synchronization signal transmitted from a base station in a mobile communication network. The synchronization signal carries a unique sequence with consecutive time-domain repetition. In step 702, the UE performs a stage-1 signal detection by self-correlating the synchronization signal and deriving a coarse location of the synchronization signal. In step 703, the UE performs a stage-2 signal detection by cross correlating the synchronization signal with a candidate sequence based on the coarse location and thereby detecting a fine location of the synchronization signal and the unique sequence.

FIG. 8 is a flow chart of a method of transmitting synchronization signals with a novel signal format for reduced cell search time. In step 801, a base station allocates radio resources in a mobile communication network. The radio resources are periodically allocated for synchronization signal transmission. In step 802, the base station transmits a synchronization signal to a plurality of UEs over the allocated radio resources. The synchronization signal is embedded with a unique sequence. The unique sequence is repeated for n times and inserted in one or more OFDM symbols in time domain. In one example, a plurality of control beams is configured to cover an entire service area of a cell for transmitting the synchronization signal. The unique sequence identifies control information comprising at least one of a cell ID and a beam ID of the base station.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
receiving a time-domain synchronization signal transmitted from a base station by a user equipment (UE) in a mobile communication network, wherein the synchronization signal carries a unique sequence with consecutive time-domain repetition;
performing a stage-1 signal detection by self-correlating the synchronization signal and deriving a coarse location of the synchronization signal; and
performing a stage-2 signal detection by cross-correlating the synchronization signal with a candidate sequence based on the coarse location and thereby detecting a fine location of the synchronization signal and the unique sequence.

2. The method of claim 1, wherein a plurality of control beams is configured to cover an entire service area of a cell for transmitting the synchronization signal.

3. The method of claim 2, wherein the unique sequence identifies control information comprising at least one of a cell ID and a beam ID of the base station.

4. The method of claim 1, wherein the unique sequence has a length of N/n and is repeated for n times in one OFDM symbol, and wherein N and n are positive integers.

5. The method of claim 4, wherein the stage-1 signal detection involves self-correlating the synchronization signal at different sampling points with N/n time distance during an observation window.

6. The method of claim 5, wherein the coarse location is determined when a correlation result is higher than a predefined threshold.

7. The method of claim 1, wherein the stage-2 signal detection involves cross correlating the synchronization signal with the candidate sequence at sampling instances near the coarse location.

8. The method of claim 7, wherein the fine location and the unique sequence is detected when a maximum correlation result is achieved among all candidate sequences.

9. A user equipment, comprising:
a receiver that receives a time-domain synchronization signal transmitted from a base station in a mobile communication network, wherein the synchronization signal carries a unique sequence with consecutive time-domain repetition;
a stage-1 signal detector that performs self-correlation of the synchronization signal and thereby deriving a coarse location of the synchronization signal; and
a stage-2 signal detector that performs cross-correlation of the synchronization signal with a candidate sequence based on the coarse location and thereby detecting a fine location of the synchronization signal and the unique sequence.

10. The UE of claim 9, wherein a plurality of control beams is configured to cover an entire service area of a cell for transmitting the synchronization signal.

11. The UE of claim 10, wherein the unique sequence identifies control information comprising at least one of a cell ID and a beam ID of the base station.

12. The UE of claim 9, wherein the unique sequence has a length of N/n and is repeated for n times in one OFDM symbol, and wherein N and n are positive integers.

13. The UE of claim 12, wherein the stage-1 signal detection involves self-correlating the synchronization signal at different sampling points with N/n time distance during an observation window.

14. The UE of claim 13, wherein the coarse location is determined when a correlation result is higher than a predefined threshold.

15. The UE of claim 9, wherein the stage-2 signal detection involves cross correlating the synchronization signal with the candidate sequence at sampling instances near the coarse location.

16. The UE of claim 15, wherein the fine location and the unique sequence is detected when a maximum correlation result is achieved among all candidate sequences.

17. A method, comprising:
allocating radio resources by a base station in a mobile communication system, wherein the radio resources are periodically allocated for synchronization signal transmissions; and
transmitting a synchronization signal to a plurality of user equipments (UEs) over the allocated radio resources, wherein the synchronization signal is embedded with a unique sequence, and wherein the unique sequence is repeated for n times and inserted in one or more OFDM symbols in time domain, wherein n is an integer greater than one.

18. The method of claim 17, wherein the base station is directionally configured with a plurality of control beams that covers an entire service area of a cell for the synchronization signal transmissions.

19. The method of claim 18, wherein the unique sequence identifies control information comprising at least one of a cell ID and a beam ID of the base station.

20. The method of claim 17, wherein the unique sequence is repeated for two times in one OFDM symbol for each synchronization signal transmission.
